(19) United States
(12) Patent Application Publication
(10) Pub. No.: US 2024/0353090 A1
(43) Pub. Date: Oct. 24, 2024

(54) TRACK ADAPTER, TRACK AND ELECTRICAL SYSTEM

(71) Applicants: SUZHOU OPPLE LIGHTING CO., LTD., Suzhou City (CN); OPPLE LIGHTING CO., LTD., Shanghai (CN)

(72) Inventor: Qie YU, Suzhou City (CN)

(73) Assignees: SUZHOU OPPLE LIGHTING CO., LTD., Suzhou City (CN); OPPLE LIGHTING CO., LTD., Shanghai (CN)

(21) Appl. No.: 18/760,083

(22) Filed: Jul. 1, 2024

Related U.S. Application Data
(63) Continuation of application No. PCT/CN2022/141544, filed on Dec. 23, 2022.

(30) Foreign Application Priority Data
Dec. 30, 2021 (CN) 202111661528.X
Dec. 30, 2021 (CN) 202123410379.8

(51) Int. Cl. F21V 21/35; F21S 8/06; H01R 25/14

(52) U.S. Cl. CPC F21V 21/35; F21S 8/066; H01R 25/14

(57) ABSTRACT

The present disclosure provides a track adapter, a track, and an electrical system. The track adapter is configured for coupling an electrical device to a track, and including: a connection body, a first clamping piece and a second clamping piece respectively movably connected to the connection body, and a power supply spring piece provided on the first clamping piece and/or the second clamping piece for electrical connection, wherein the first clamping piece and the second clamping piece are disposed facing each other from opposite sides of the connection body, and the first clamping piece, the second clamping piece and the connection body enclose to form an accommodating space at least partially housing the track.

### CROSS-REFERENCE TO RELATED APPLICATION(S)

This application is based upon and claims the priority of PCT patent application No. PCT/CN2022/141544 filed on Dec. 23, 2022 which claims priority to the Chinese patent application No. 202123410379.8 filed on Dec. 30, 2021, and the Chinese patent application No. 202111661528.X filed on Dec. 30, 2021, the entire contents of which are hereby incorporated by reference herein for all purposes.

### TECHNICAL FIELD

The present disclosure relates to the technical field of lighting, in particular to a track adapter, a track, and an electrical system.

### BACKGROUND

Track lamps mainly include tracks (conductive tracks) fixed on a ceiling or wall and various lamps that can slide along the tracks, which can be spotlights, line lights and so on.

### SUMMARY

The present disclosure provides a track adapter, a track, and an electrical system.

The present disclosure provides a track adapter that may be configured for coupling an electrical device to a track. The track adapter may include: a connection body, a first clamping piece and a second clamping piece movably connected to the connection body, and a power supply spring piece provided on the first clamping piece and/or the second clamping piece for electrical connection, wherein the first clamping piece and the second clamping piece are disposed facing each other from opposite sides of the connection body, and the first clamping piece, the second clamping piece and the connection body enclose to form an accommodating space at least partially housing the track.

The present disclosure also provides a track that may be matched and connected with the abovementioned track adapter. The track may be configured to be mechanically connected and electrically connected with the abovementioned track adapter.

The present disclosure further provides an electrical system which may include the abovementioned track adapter. The electrical system may include the abovementioned track adapter; and the electrical system may further include a track and an electrical device, where the electrical device may be coupled to the track through the track adapter.

It is to be understood that both the foregoing general description and the following detailed description are exemplary and explanatory only and are not restrictive of the present disclosure.

### BRIEF DESCRIPTION OF DRAWINGS

Hereinafter, the technical scheme and other beneficial effects of the present disclosure will be obvious by describing the examples of the present disclosure in detail with the attached drawings.

FIG. 1 is a perspective view of a track according to an example of the present disclosure.

FIG. 2 is a sectional view of FIG. 1

FIG. 3 is a perspective view from another angle of FIG. 1.

FIG. 4 is a sectional view of a first installation mode of FIG. 1.

FIG. 5 is a sectional view of a second installation mode of FIG. 1.

FIG. 6 is a perspective view of an adapter according to an example of the present disclosure.

FIG. 7 is a perspective view of a track light group according to a first example of the present disclosure.

FIG. 8 is a perspective view of a track light group according to a second example of the present disclosure.

FIG. 9 is a perspective view of a track light group according to a third example of the present disclosure.

FIG. 10 is a perspective view of a track light group according to a fourth example of the

present disclosure.

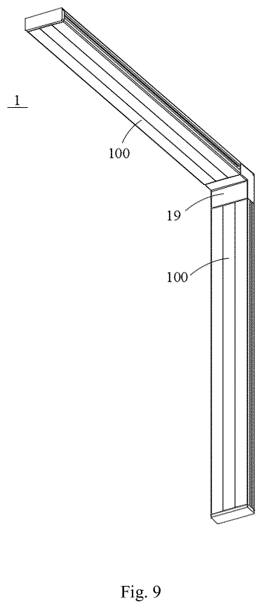

FIG. 9 is a perspective view of a track light group according to a fifth example of the present disclosure.

FIG. 12 is a perspective view of a track adapter according to an example of the present disclosure.

FIG. 13 is a top view of FIG. 12 with an upper housing removed.

FIG. 14 is an exploded view of a structure of FIG. 12.

FIG. 15 is an exploded view of a structure of a second clamping piece in FIG. 14.

FIG. 16 is a perspective view of a power supply spring piece in FIG. 14

FIG. 17 is a perspective view of an unlocking assembly in FIG. 14.

FIG. 18 is a partial structural perspective view of a connection body in FIG. 14.

FIG. 19 is a sectional view of FIG. 12.

FIG. 20 is a perspective view of an electrical system of the first example of the present disclosure.

FIG. 21 is a side view of FIG. 20.

FIG. 22 is an exploded view of a structure of FIG. 20.

FIG. 23 is a sectional view of FIG. 20.

FIG. 24 is a partial structural sectional view of FIG. 20.

FIG. 25 is a schematic view of an unlocked state of the electrical system of FIG. 20.

FIG. 26 is a schematic view of a locking state of the electrical system of FIG. 20.

FIG. 27 is a perspective view of an electrical system of the second example of the present disclosure.

### DETAILED DESCRIPTION

In order to make the purpose, technical solution and advantages of the present disclosure more clear, the disclosure will be described in detail with the attached drawings and examples.

Here, it should be noted that, in order to avoid obscuring the present disclosure with unnecessary details, only the structure and/or processing steps closely related to the technical solution of the present disclosure are shown in the attached drawings, while other details that are not related to the present disclosure are omitted.

In addition, it should be noted that the terms “including”, “including” or any other variation thereof are intended to cover non-exclusive inclusion, so that a process, method, article or equipment including a series of elements includes not only those elements, but also other elements not explicitly listed, or elements inherent to such process, method, article or equipment.

Description of reference signs in this disclosure may include:
100—track,
1—track light group, 11—main body, 111—top wall, 1111—installation hole, 1112—traction structure, 112—bottom wall, 113—left sidewall, 114—right sidewall, 121—first guide groove, 122—second guide groove, 123—opening part, 124—fixing surface, 125—upper surface, 126—lower surface, 13—power supply conductive piece, 14—signal conductive piece, 15—insulating piece, 151—opening, 16—supporting part, 161—accommodating groove, 162—fixing hole, 17—lighting assembly, 171—base plate, 172—light-emitting piece, 173—light-exiting part, 1731—bottom plate, 1732—side plate, 18—end cap, 19—conversion connector, 191—insulating body, 192—conductive terminal, 193—butting part,
200—track adapter,
21—connection body, 211—housing, 2111—upper housing, 2112—lower housing, 2113—installation space, 2114—through hole, 2115—connection hole, 212—combining part, 2121—first limiting baffle, 2122—second limiting baffle, 2123—hollow fixing post, 213—limiting groove, 214—guide part, 215—baffle, 2151—second sleeve joint part, 216—accommodating groove, 221—first clamping piece, 222—second clamping piece, 223—first part, 2231—first abutting surface, 2232—second abutting surface, 2233—upper cover, 2234—lower groove body, 2235—connection opening, 2236—vertical sidewall, 224—second part, 2241—connection end, 2242—protruding part, 2243—first retaining wall, 225—third part, 23—power supply spring piece, 231—fixing part, 232—abutting part, 24—signal spring piece, 25—accommodating space, 251—first space, 252—second space, 26—locking assembly, 261—locking part, 2611—first wall, 2612—second wall, 262—first elastic member, 27—unlocking assembly, 271—pressing part, 2711—second retaining wall, 272—movable plate, 2721—yielding part, 2722—engagement part, 2723—reinforcing plate, 2724—first sleeve joint part, 273—second elastic member, 28—hollow connection rod,
300—electrical device,
400—electrical system.

Sometimes, the track is relatively large in size and relatively high in height, which may occupy high-rise space when used indoors and affect the use effect. Moreover, at present, most of the track lamps in the market are magnetic attraction track lamps, and the lamp body is directly connected with the track by magnetic force. Then, when the lamp body is rotating or swinging, because of the lever principle or shearing force on the magnetic force, the lamp body may fall off or the contact of the power-taking contact may be poor, resulting in potential safety hazards.

In view of this, it is really needed to provide a track adapter, a track and an electrical system to solve the above problems.

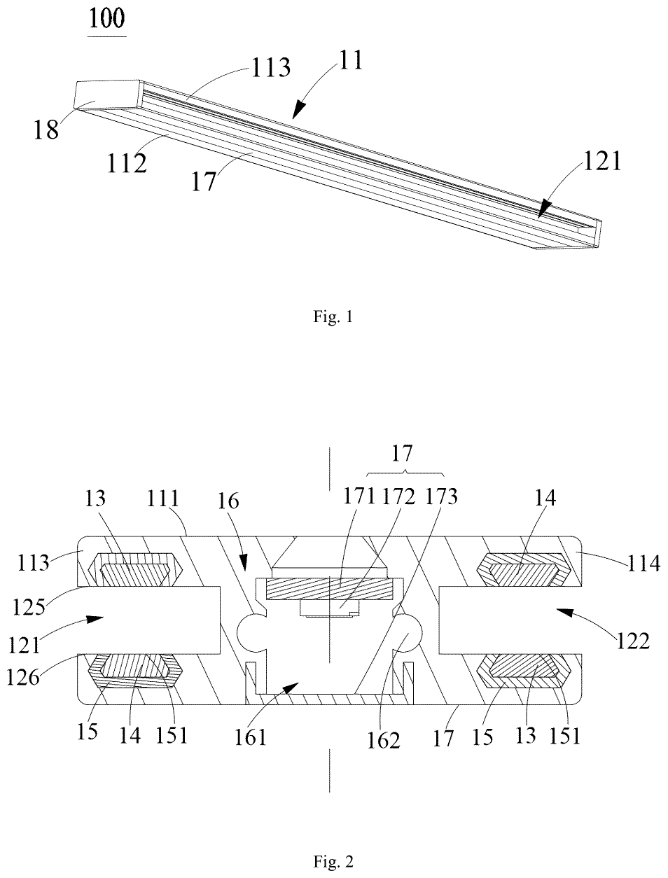

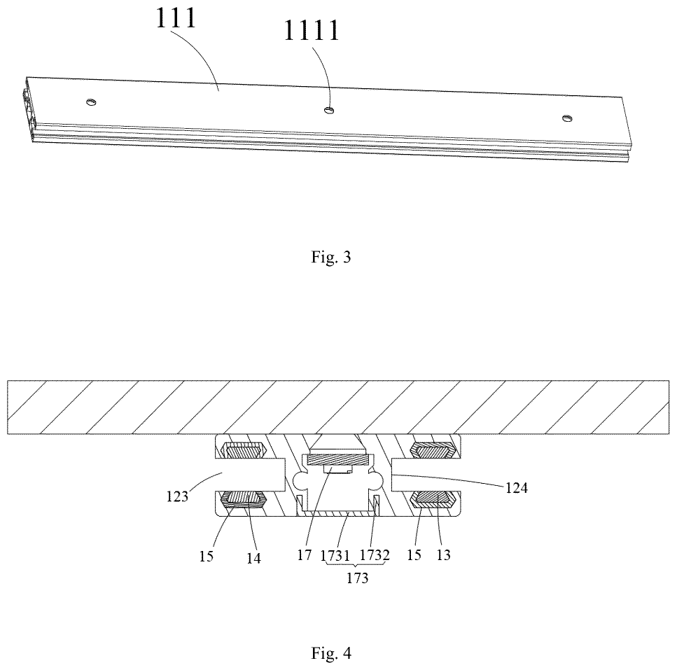

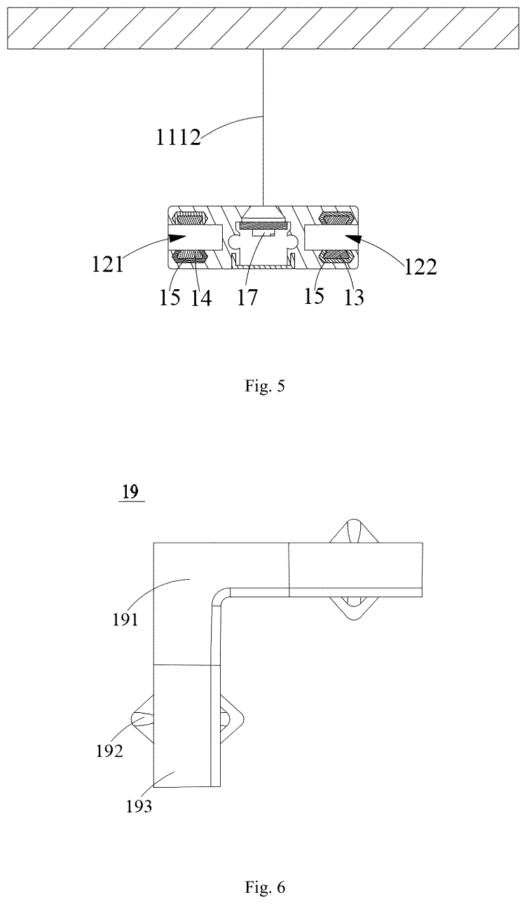

Please refer to FIGS. 1-5, which show a track 100 according to an example of the present disclosure. The track 100 is made of rigid material and has a long flat shape, which is used for assembling on an installation foundation and can be coupled with an electrical device 300 through a track adapter 200 to form an electrical system 400, or the electrical device 300 can be coupled with the track 100 through the track adapter 200 to form the electrical system 400 (see FIGS. 20 and 27). In this example, the track 100 is made of aluminum alloy material, so that the track 100 has advantages of light weight, strong corrosion resistance and stable chemical properties while having a rigid supporting function. In other examples, the track 100 can also be made of other rigid conductive materials or insulating materials, which is not limited by the present disclosure.

The track 100 includes a main body 11 and a power supply conductive piece 13 arranged in the main body 11. The main body 11 extends along a length direction and includes a width direction and a thickness direction both perpendicular to the length direction, and the main body 11 includes a top wall 111 for assembling with the installation foundation, a bottom wall 112 arranged opposite to the top wall 111, and a left sidewall 113 and a right sidewall 114 both arranged between the top wall 111 and the bottom wall 112. The top wall 111 and the bottom wall 112 of the track 100 both extend along the length direction and width direction of the track 100, and the left sidewall 113 and the right sidewall 114 of the track 100 extend along the length direction and thickness direction of the track 100.

A side of the top wall 111 of the track 100 facing the installation foundation is provided with a plurality of installation holes 1111, and a number of the installation holes 1111 is set according to a length of the track 100, which is not limited by the present disclosure. The plurality of installation holes 1111 are uniformly distributed along the length direction of the track 100 for fixing the track 100 on the installation foundation. Alternatively, the track 100 of the present disclosure can be a surface-mounted track 100 or a suspension-mounted track 100, which is not limited by the present disclosure. In the case that the track 100 of the present disclosure is used as the surface-mounted track 100, the installation foundation can be a ceiling or a wall, and fasteners such as screws pass through the installation holes 1111, and heads of the fasteners are finally pressed on two sides of the installation holes 1111 of the top wall and locked with the installation foundation to fix the track 100 on the installation foundation. In the case that the track 100 of the present disclosure is used as the suspension-mounted track 100, the track 100 is fixed on the installation foundation through a traction structure.

Please continue to refer to FIGS. 1-5 in conjunction with FIGS. 20-24, both the left sidewall 113 and the right sidewall 114 of the track 100 are recessed in a direction of approaching each other to form a first guide groove 121 and a second guide groove 122 suitable for mechanical connection, that is to say, the track 100 is arranged in an I-shape, and both the left sidewall 113 and the right sidewall 114 of the track 100 are recessed towards an inside of the main body 11 to form the first guide groove 121 and the second guide groove 122. The main body 11 includes a central axis perpendicular to the width direction, and the first guide groove 121 and the second guide groove 122 are symmetrically arranged along the central axis and extend along the length direction of the track 100.

Both the first guide groove 121 and the second guide groove 122 include an opening part 123 away from the central axis and a fixing surface 124 close to the central axis. That is to say, the first guide groove 121 and the second guide groove 122 are both in an inverted U-shape and communicate with the outside, and the opening parts 123 of the first guide groove 121 and the second guide groove 122 are arranged on outer wall surfaces of the left sidewall 113 and the right sidewall 114. A first clamping piece 221 and a second clamping piece 222 of a track adapter 200 are inserted into the first guide groove 121 and the second guide groove 122 of the track 100 from the opening parts 123, and are mechanically connected with the track 100, and can slide in the first guide groove 121 and the second guide groove 122 along the length direction of the track 100. With this arrangement, the track adapter 200 can be connected with the track 100 in a matching way from outer side surfaces of the track 100, thus avoiding the problem in the existing art that the track 100 needs to vertically extend downward to form a guide groove and to get electricity from an inner side, a thickness of the track 100 is effectively reduced and an occupied space of the track 100 is reduced. Meanwhile, the mechanical connection mode adopting the first guide groove 121 and the second guide groove 122 can avoid the potential safety hazard caused by the falling of the electrical device 300 due to the unstable magnetic connection, and the stability and safety of the connection with the track 100 is improved.

Both the first guide groove 121 and the second guide groove 122 include an upper surface 125 and a lower surface 126 which are oppositely arranged along the length direction of the main body 11. Extension lengths of the upper surface 125 and the lower surface 126 in the width direction of the main body 11 is longer than a vertical distance between the upper surface 125 and the lower surface 126, so as to increase a contact area between the track 100 and the track adapter 200 and improve the stability and safety of the connection with the track 100.

At least two power supply conductive pieces 13 are provided, the at least two power supply conductive pieces 13 are in a flat and strip shape, and are a positive electrode and a negative electrode respectively, the at least two power supply conductive pieces 13 are inserted into the main body 11, and peripheral walls of the at least two power supply conductive pieces 13 are wrapped by insulating pieces 15 to play a role of separation and insulation, so as to avoid short circuit in the case that the track 100 is made of conductive materials. In the case that the track 100 is made of insulating materials, the insulating pieces 15 can also be omitted. The insulating pieces 15 include openings 151 at the sides facing the first guide groove 121 and the second guide groove 122, so that the power supply conductive piece 13 can be exposed outside of the insulating piece 15 and at least partially exposed in the first guide groove 121 and/or the second guide groove 122. Preferably, both the power supply conductive piece 13 and the insulating piece 15 are arranged on the upper surface 125 and/or the lower surface 126. A shape of the insulating piece 15 matches a shape of the power supply conductive piece 13, the insulating piece 15 is wrapped on the peripheral wall of the power supply conductive piece 13, and the insulating piece 15 is provided with an opening 151 at a side of the power supply conductive piece 13 close to the upper surface 125 and/or the lower surface 126, so that the power supply conductive piece 13 is exposed on the upper surface 125 and/or the lower surface 126, and further at least partially exposed in the first guide groove 121 and/or the second guide groove 122. With this arrangement, the track 100 and the track adapter 200 can be electrically connected while being mechanically connected through the first guide groove 121 and the second guide groove 122, which is convenient and quick.

In an alternative example, four power supply conductive pieces 13 can also be provided, and the four power supply conductive pieces 13 include two positive electrodes and two negative electrodes, which are respectively arranged on the upper surfaces 125 and the lower surfaces 126 of the first guide groove 121 and the second guide groove 122, so that the track 100 has a dual electrical circuit to meet a demand of independent control of two-way output of dimming and toning products in a market trend, and can also be independently controlled for each channel of four wires and three circuits, or a combination of the power supply conductive pieces 13 can also be deleted according to the requirement disclosure of actual circuit.

Further, in order to improve an intelligence of the electrical system 400 with the track 100, the track 100 further includes at least two signal conductive pieces 14, which are in a flat and strip shape, and can be in contact with signal spring pieces 24 on the track adapter 200 to form a control circuit (FIG. 24). Outer peripheral walls of the signal conductive pieces 14 are wrapped with the insulating pieces 15, and a shape of the insulating piece 15 matches a shape of the signal conductive piece 14 to play a role of insulation and separation. The insulating piece 15 is provided with an opening 151 at a side of the signal conductive piece 14 close to the upper surface 125 and/or the lower surface 126, so that the signal conductive piece 14 is at least partially exposed on the upper surface 125 and/or the lower surface 126, and then at least partially exposed inside the first guide groove 121 and/or the second guide groove 122, so as to realize intelligent control of the track 100.

In an alternative example, the track 100 includes two power supply conductive pieces 13 and two signal conductive pieces 14, the two power supply conductive pieces 13 and the two signal conductive pieces 14 are staggered along the central axis of the main body 11. For example, the two power supply conductive pieces 13 are respectively arranged on the upper surface 125 of the first guide groove 121 and the lower surface 126 of the second guide groove 122. The two signal conductive pieces 14 are respectively arranged on the lower surface 126 of the first guide groove 121 and the upper surface 125 of the second guide groove 122. In the case that the track adapter 200 is connected with the track 100, the two power supply conductive pieces 13 and the two signal conductive pieces 14 are respectively in contact with the two power supply spring pieces 23 and the two signal spring pieces 24 on the track adapter 200 to form an electrical circuit and a control circuit at the same time. It can be known that the power supply conductive pieces 13 and the signal conductive pieces 14 can also be staggered along the central axis of the main body 11 in other ways, or the signal conductive pieces 14 and the power supply conductive pieces 13 are symmetrically arranged along the central axis of the main body 11, or the signal conductive pieces 14 and the power supply conductive pieces 13 are symmetrically arranged along a direction perpendicular to the central axis. In other words, the power supply conductive pieces 13 and the signal conductive pieces 14 can be interchanged left and right or interchanged up and down on the upper surfaces 125 and the lower surfaces 126 of the first guide groove 121 and the second guide groove 122, as long as the electrical circuit and the control circuit can be formed in the case that the track 100 is connected with the track adapter 200. In this example, both the power supply conductive pieces 13 and the signal conductive pieces 14 are copper bars. The copper bars have high conductivity and low cost, which are a good choice for electrical connection. In other examples, the power supply conductive pieces 13 and the signal conductive pieces 14 can also be made of other spring metal materials, and a scope of the present disclosure is not limited in this aspect.

In a case of four-wire configuration for power supply and control, two power supply conductive pieces 13 and two signal conductive pieces 14 are respectively arranged on the upper surfaces 125 and the lower surfaces 126 of the first guide groove 121 and the second guide groove 122. In the case that the track 100 is mechanically connected with the track adapter 200, the two power supply conductive pieces 13 and the two signal conductive pieces 14 can respectively realize the electrical circuit and the control circuit with the two power supply spring pieces 23 and the two signal spring pieces 24 on the track adapter 200 (FIG. 24). This arrangement can solve the problem that, in the existing art, the power supply conductive pieces 13 are arranged on the fixing surfaces 124 located inside the first guide groove 121 and the second guide groove 122, in the case that four-wire configuration for power supply and control are required, at least two pairs of guide grooves need to be arranged on a vertical surface of the track 100, which makes the track 100 relatively large in size and relatively high in height and affects an overall appearance of the track 100. In the existing art, in order to meet the case of four-wire configuration for power supply and control, a width of the track 100 is generally 30 mm, while a thickness of the track 100 is generally in a range from 20 mm to 30 mm, which makes the track 100 relatively thick and occupies a relatively large area. In this example, under the condition of satisfying the use of power supply and control and without changing a width of the track 100, the thickness of the track 100 is less than or equal to 8 mm, and a ratio between the thickness of the track 100 and a width of the track 100 is less than ⅓, which hardly takes up space, thus effectively solving the problem that the track 100 occupies the floor height and improving the present disclosure scope of the track 100. As a variation, in the case that four power supply conductive pieces 13 form at least two power supply circuits, the thickness of the track 100 can also be effectively reduced by arranging the four power supply conductive pieces 13 on the upper surfaces 125 and the lower surfaces 126 of the first guide groove 121 and the second guide groove 122, which is not limited by the present disclosure.

Further, the track 100 further includes a supporting part 16 connecting the top wall 111 and the bottom wall 112 along the thickness (height) direction, and the supporting part 16 is located between the first guide groove 121 and the second guide groove 122 along the width direction, the supporting part 16 is used for supporting the track 100, enhancing an overall strength, and can be used as a basis for arranging a lighting assembly 17. The supporting part 16 is provided with an accommodating groove 161 penetrating through the top wall 111 and/or the bottom wall 112, and at least one group of lighting assemblies 17 are arranged in the accommodating groove 161, and the lighting assemblies 17 are arranged between the first guide groove 121 and the second guide groove 122 in the width direction and emit light toward the top wall 111 and/or the bottom wall 112. With this arrangement, under the premise of not affecting the use of the track 100, the track 100 can further provide its own auxiliary lighting, avoiding the lack of lighting supplement in a part of the track 100 where a lighting fixture is not installed, effectively utilizing the space of the track 100, improving the lighting environment and lighting effect, and meeting the requirements of zonal lighting.

In an alternative example, the supporting part 16 is provided with the accommodating groove 161 penetrating through the bottom wall 112, and a group of lighting assemblies 17 are arranged in the accommodating groove 161, and the lighting assemblies 17 are arranged between the first guide groove 121 and the second guide groove 122 in the width direction and emit light in a direction toward the bottom wall 112. The lighting assembly 17 includes a base plate 171 and a light-emitting piece 172, the base plate 171 extends along the length direction of the track 100 and fixed at a side of the top wall 111 close to the bottom wall 112, and the light-emitting piece 172 arranged at a side of the base plate 171 away from the top wall 111 and emits light toward the bottom wall 112. Preferably, the light-emitting piece 172 is an LED light bead, and the LED light beads are uniformly arranged at the side of the base plate 171 away from the top wall 111 to provide independent illumination for the track 100. Optionally, the lighting assembly 17 can use RGB color light sources to set off the atmosphere.

In the case that the first guide groove 121 and the second guide groove 122 of the track 100 are coupled with lighting fixtures, the lighting fixtures can provide main lighting, and the lighting assembly 17 can provide auxiliary lighting, so as to effectively use the space of the track, meeting the requirements of zonal lighting, create multi-level light, and improve the user experience. The lighting fixtures and lighting assemblies 17 can be controlled separately, or in a lighting environment without special requirements, only auxiliary lighting provided by the lighting assemblies 17 on the track 100 can be used to increase the atmosphere and improve the diversified functions of the track 100.

The lighting assembly 17 further includes a light-exiting part 173, which is arranged in the accommodating groove 161 close to the bottom wall 112 and is fixedly connected with the supporting part 16. The light-exiting part 173 includes a bottom plate 1731 and a side plate 1732 extending from the bottom plate 1731 in a direction close to the top wall 111. The supporting part 16 is provided with a clamping groove corresponding to the side plate 1732, and the side plate 1732 extends into the clamping groove to be engaged with the supporting part 16. A plane where a lowest point of the light-exiting part 173 is located is flush with a plane where a lowest point of the bottom wall 112 is located, so as to improve the aesthetics of the track 100 without affecting the overall thickness of the track 100, and maintain the ultra-thin structure of the track 100.

As a variation, the supporting part 16 may be provided with an accommodating groove 161 penetrating through the top wall 111, a group of lighting assemblies 17 are arranged in the accommodating groove 161, and the lighting assemblies 17 are arranged in the accommodating groove 161 between the first guide groove 121 and the second guide groove 122 in the width direction and emit light in a direction toward the top wall 111. In this case, a plane where the highest point of the light-exiting part 173 is located is flush with a plane where the highest point of the top wall 111 is located, so as to improve the aesthetics of the track 100 without affecting the overall thickness of the track 100, and maintain the ultra-thin structure of the track 100. Or, the supporting part 16 is provided with an accommodating groove 161 penetrating through the top wall 111 and the bottom wall 112, and two groups of lighting assemblies 17 are arranged in the accommodating groove 161, the two groups of lighting assemblies 17 are both arranged between the first guide groove 121 and the second guide groove 122 in the width direction, and are respectively arranged at positions close to the top wall 111 and the bottom wall 112, and emit light in the directions toward the bottom wall 112 and toward the top wall 111 respectively. In this case, there are two light-exiting parts 173, which are respectively arranged in the accommodating groove 161 close to the top wall 111 and the bottom wall 112 and are fixedly connected with the supporting part 16. The plane of the highest point of the light-exiting part 173 on the top wall 111 is flush with the plane of the highest point on the top wall 111, and the plane of the lowest point of the light-exiting part 173 on the bottom wall 112 is flush with the plane of the lowest point on the bottom wall 112.

The light-exiting part 173 can be a diffusion plate or a light guide plate, so that the light-exiting part 173 can evenly and gently diffuse the light irradiated by the light-emitting pieces 172 toward the top wall 111 and/or the bottom wall 112 while blocking the accommodating groove 161, thereby reducing the formation of paragraph-like light spots caused by the spaced arrangement of the light-emitting pieces 172, and meanwhile preventing dust from entering the accommodating groove 161 and affecting the service life of the lighting assembly 17.

Optionally, the lighting assembly 17 may further include a light distribution piece (not shown), such as a lens, a reflector, etc. The lens and/or reflector may be arranged in one-to-one correspondence with the light-emitting pieces 172, or one lens and/or reflector may be shared by a plurality of light-emitting pieces 172, which is not limited by the present disclosure.

In an alternative example, the supporting part 16 is provided with an accommodating groove 161 penetrating through the top wall 111 and the bottom wall 112, and a group of lighting assemblies 17 are arranged in the accommodating groove 161, which are arranged between the first guide groove 121 and the second guide groove 122 in the width direction, and the lighting assemblies 17 are arranged at a position close to the top wall 111, and the light-emitting piece 172 is arranged at the side of the base plate 171 away from the top wall 111 and emits light toward the bottom wall 112, and an annular reflector is arranged in a light-exiting direction of the light-emitting piece 172. A central ring of the annular reflector can transmit light, and an annular wall of the reflector around the central ring can reflect light, so that a part of the light emitted by light-emitting piece 172 is exited in the direction toward the bottom wall 112 through the central ring of the reflector, and another part of the light emitted by light-emitting piece 172 is exited in the direction toward the top wall 111 after being reflected by the annular wall of the reflector, therefore, by arranging one group of lighting assemblies 17 in the track 100, the light emitted by the group of lighting assemblies 17 can be exited in the directions toward the top wall 111 and the bottom wall 112 at the same time, thereby improving the aesthetics of the track 100, and maintaining the ultra-thin structure of the track 100 without affecting the overall thickness of the track 100.

As a variation, two groups of lighting assemblies 17 can also be arranged in the track 100, and the light distribution pieces are arranged in the accommodating groove 161, so that the two groups of lighting assemblies 17 can emit light in the direction toward the top wall 111 or the bottom wall 112 at the same time, which is not limited in the present disclosure.

Further, the lighting assembly 17 is integrally formed with the track 100, and the lighting assembly 17 is contained inside the track 100, so that it can provide decorative lighting on the premise of not affecting the use of the track 100, and the overall structure is simple and the shape is beautiful.

Further, the track 100 further includes end caps 18 arranged at two ends of the main body 11, and the end caps 18 are mechanically connected with the main body 11. Optionally, the supporting part 16 is provided with fixing holes 162, and fasteners pass through the fixing holes 162 to fixedly connect the end caps 18 with the track 100, but the present disclosure is not limited thereto. By arranging the end cap 18, the aesthetics of the track 100 can be improved, and meanwhile, the performance of the lighting assembly 17 in the track 100 can be prevented from being affected by dust entering the accommodating groove 161.

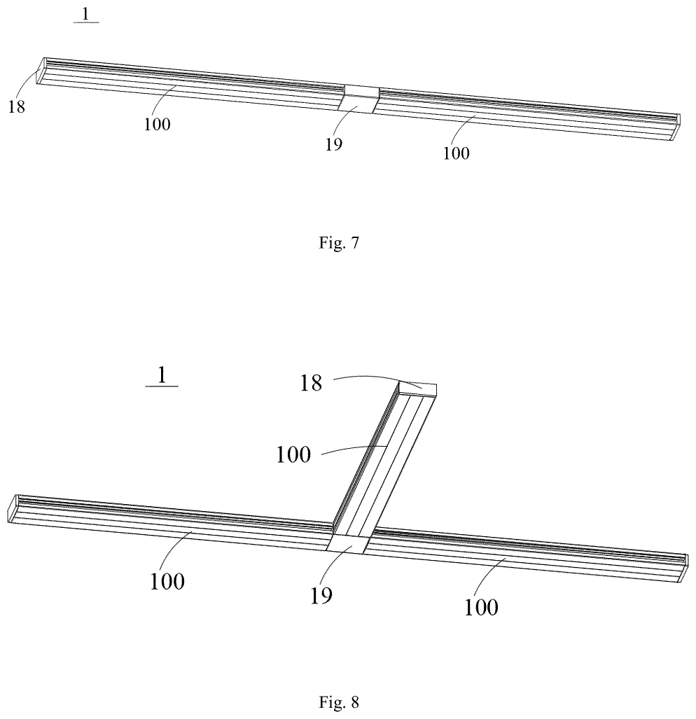

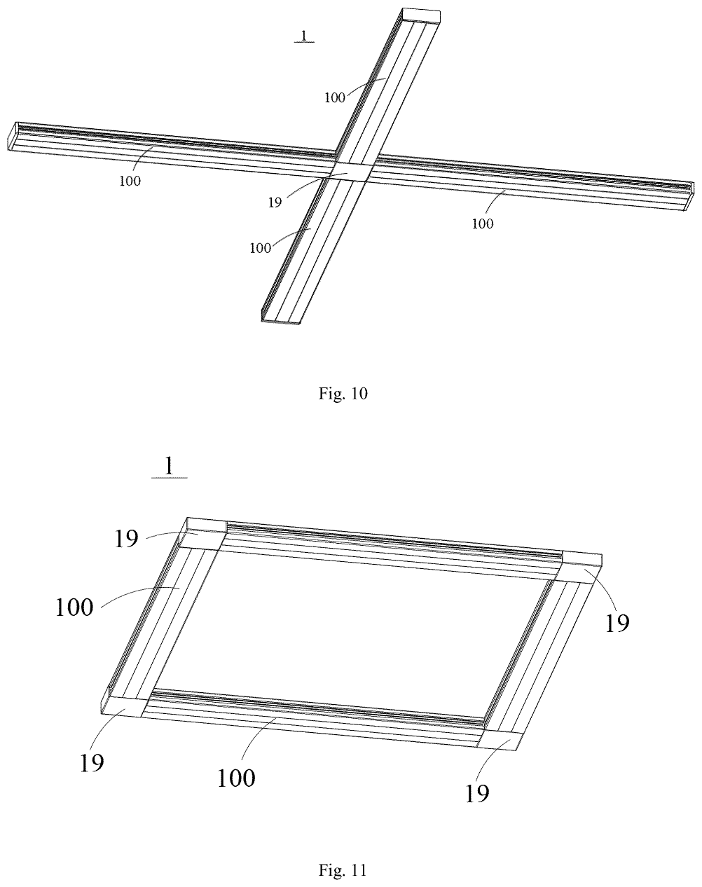

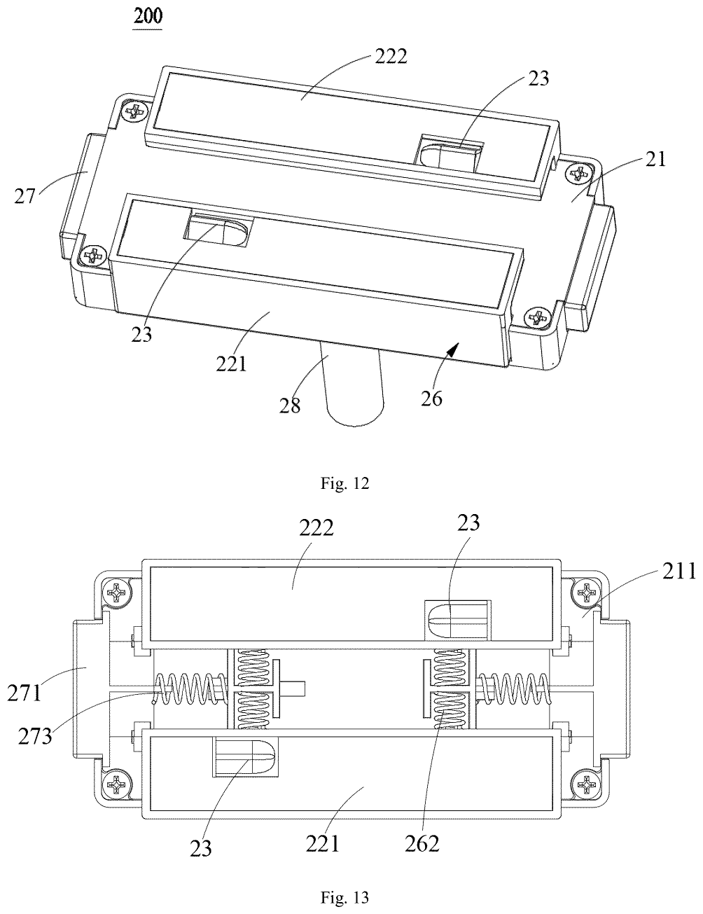

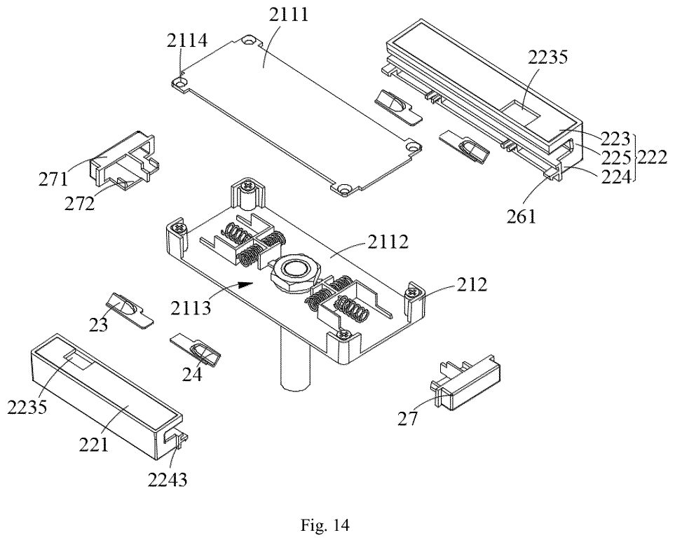

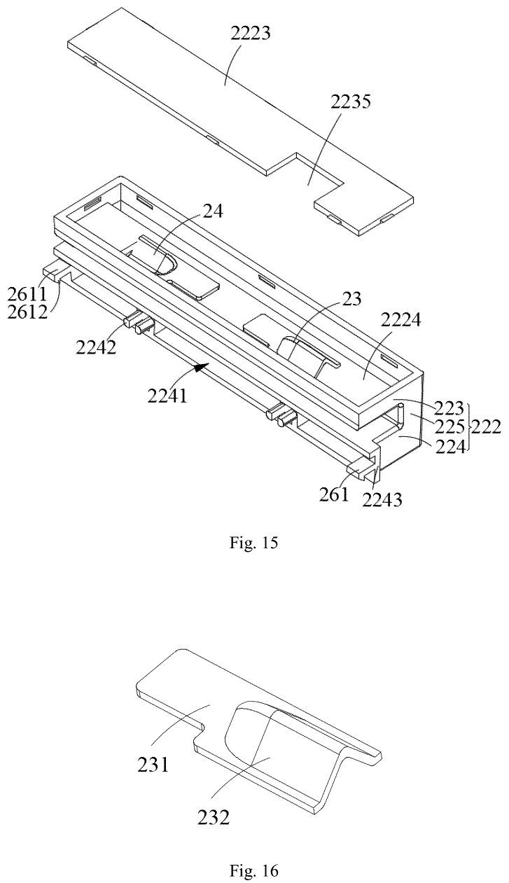

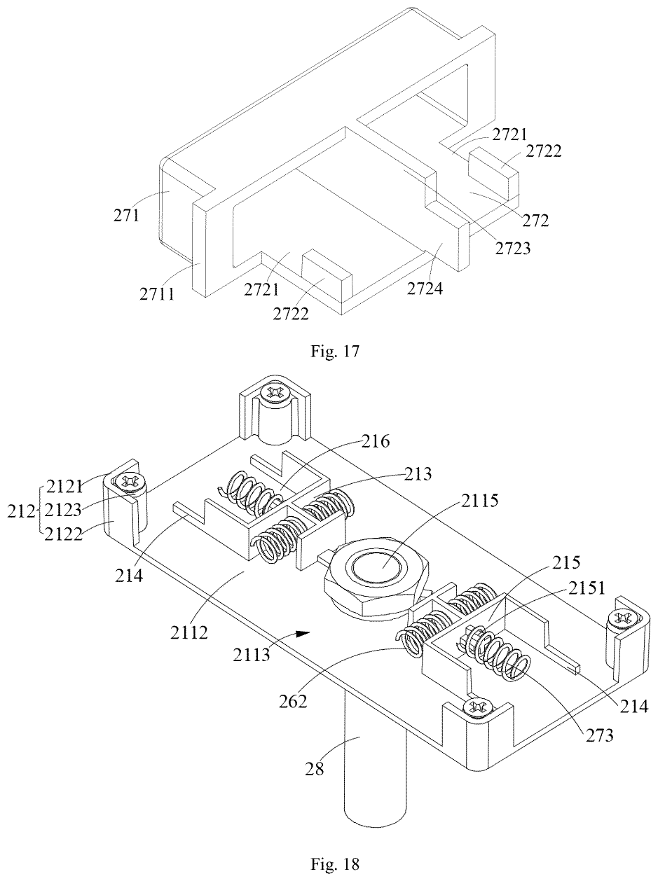

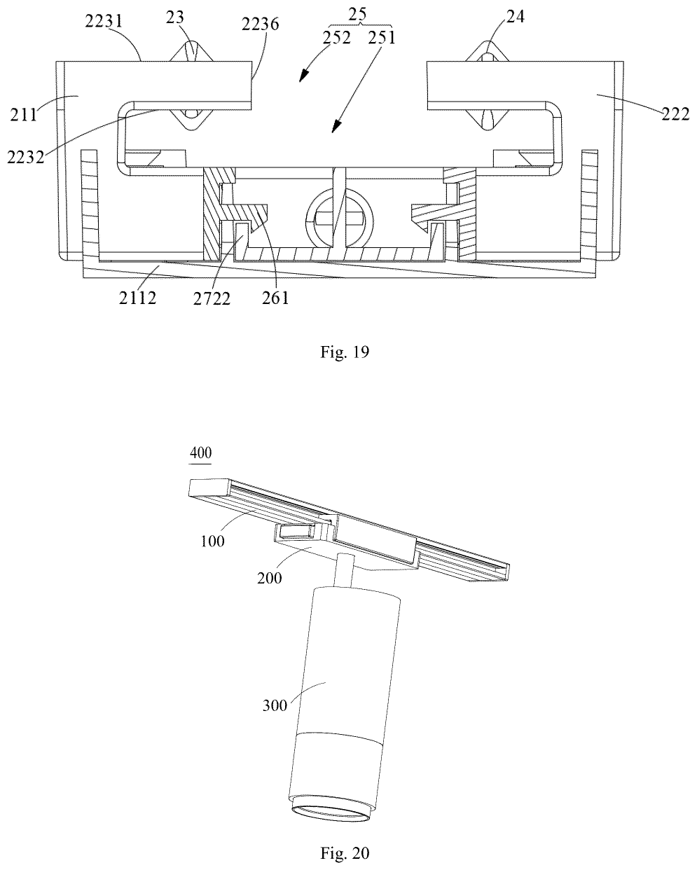

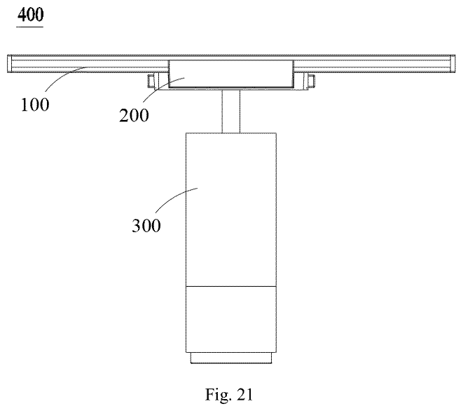

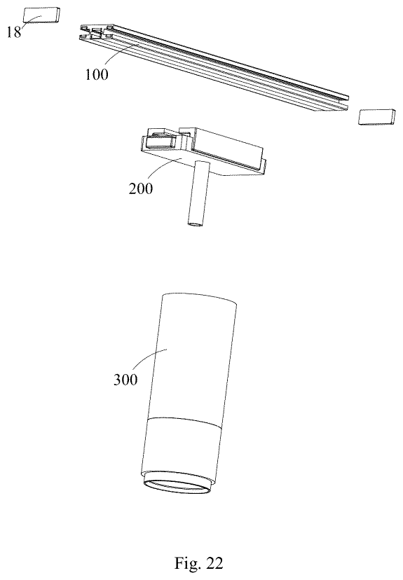

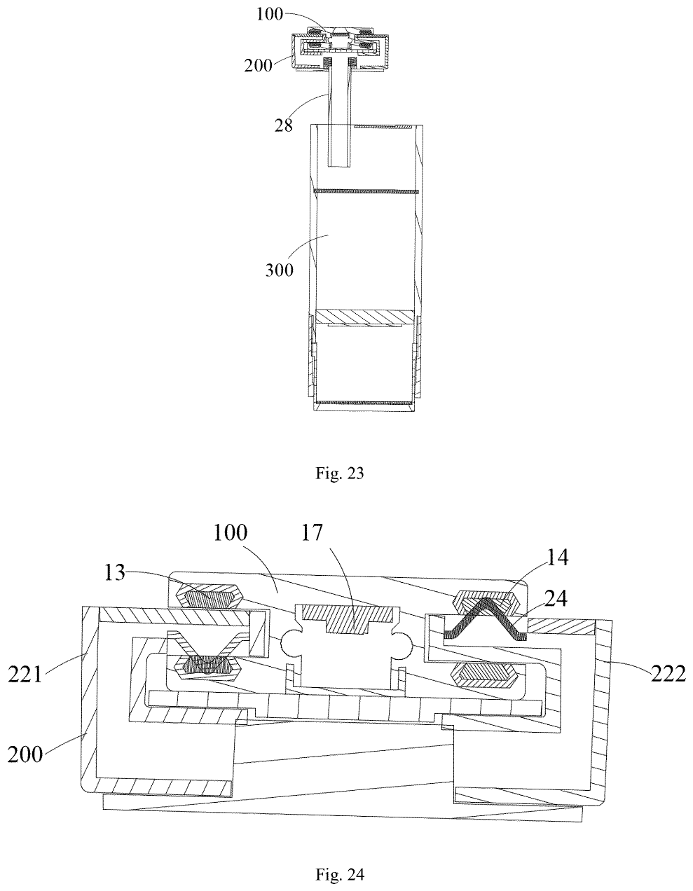

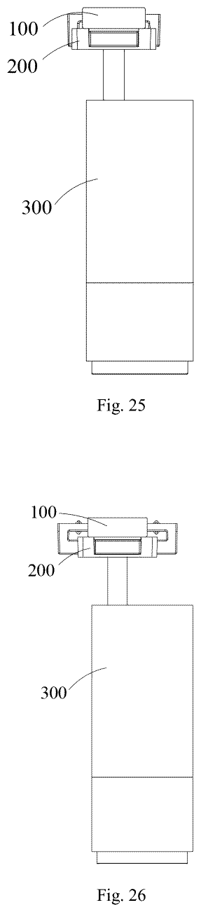

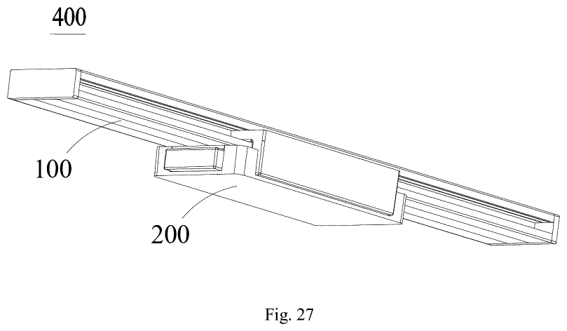

Please refer to FIGS. 6-11, the track 100 further includes a conversion connector 19, the conversion connector 19 is configured to cascade at least two tracks 100, and the at least two tracks 100 are mechanically and electrically connected through the conversion connector 19. The tracks 100 are cascaded into different track light groups 1 through conversion connectors 19 to meet more lighting requirements.

Further, the conversion connector 19 includes an insulating body 191, and a conductive terminal 192 and a butting part 193, the conductive terminal 192 is arranged in the insulating body 191 and partially protrude from the insulating body 191. At least two conductive terminals 192 are provided, the at least two conductive terminals 192 are a positive electrode and a negative electrode respectively, the at least two conductive terminals 192 correspond to the at least two power supply conductive pieces 13 of the track 100. Because the at least two power supply conductive pieces 13 of the track 100 are located on the upper surfaces 125 and the lower surfaces 126 of the first guide groove 121 and/or the second guide groove 122, correspondingly, the conductive terminals 192 of the conversion connector 19 are arranged on a top surface or a bottom surface of the butting part 193, so that in the case that the butting part 193 extends into the first guide groove 121 and the second guide groove 122 of the at least two tracks 100, the conductive terminals 192 and the power supply conductive pieces 13 are electrically connected. So that the at least two tracks 100 are mechanically and electrically connected through the conductive terminals 192 and the butting part 193 of the conversion connector 19 to form the track light group 1.

According to the requirements of the required track light group 1, the conversion connectors 19 with different structures are selected to have different structures, so that the structures of the cascaded track light groups 1 are different. Optionally, the structure of the conversion connector 19 includes, but is not limited to, straight-line, T-shaped, cross-shaped, mouth-shaped and L-shaped facades and other structures, so the shape of the track light group 1 can be correspondingly formed into straight-line, T-shaped, cross-shaped, mouth-shaped and L-shaped facades and other shapes, the present disclosure is not limited thereto, so as to meet the diverse needs of users. Alternatively, the track 100 can be mechanically and electrically connected with various electrical devices 300 through the conversion connector 19, which improves the present disclosure range of the track 100 and is convenient and reliable.

Please refer to FIGS. 12-19 in conjunction with FIGS. 20-26, the present disclosure provides a track adapter 200 of an example, the track adapter 200 is used to be clamped to the track 100 to realize mechanical connection with the track 100 and electrical connection at the same time.

The track adapter 200 includes a connection body 21, a first clamping piece 221 and a second clamping piece 222 movably connected with the connection body 21 respectively, a power supply spring piece 23 arranged on the first clamping piece 221 and/or the second clamping piece 222 for electrically connecting with the track 100, and a pressing part 271 positioned between the first clamping piece 221 and the second clamping piece 222 and movably connected with the connection body 21. Define a direction in which the first clamping piece 221 and the second clamping piece 222 move relative to the connection body 21 as a first direction, and a direction perpendicular to the moving direction as a second direction.

The first clamping piece 221 and the second clamping piece 222 are arranged to face each other from opposite sides of the connection body 21, that is to say, both the first clamping piece 221 and the second clamping piece 222 are arranged in a direction close to the connection body 21, and the first clamping piece 221 and the second clamping piece 222, together with the connection body 21, surround and define an accommodating space 25 for accommodating at least a part of the track 100. The accommodating space 25 is generally configured in a convex shape structure, the accommodating space 25 includes a first space 251 and a second space 252 which are communicated with each other. The first space 251 is surrounded by a housing 211 of the connection body 21, a third part 225 of the first clamping piece 221 and a third part 225 of the second clamping piece 222. The second space 252 is surrounded by a vertical sidewall 2236 of the first clamping piece 221 close to the second clamping piece 222 and a vertical sidewall 2236 of the second clamping piece 222 close to the first clamping piece 221. Because the first clamping piece 221 and the second clamping piece 222 are arranged to face each other, a distance of the second space 252 is smaller than a distance of the first space 251 in the first direction, so that the convex-shaped accommodating space 25 is just matched with the I-shaped track 100.

In the case that the first clamping piece 221 and the second clamping piece 222 of the track adapter 200 respectively enter the first guide groove 121 and the second guide groove 122 from the left sidewall 113 and the right sidewall 114 of the track 100, the first clamping piece 221 and the first guide groove 121 are in face-to-face contact, and the second clamping piece 222 and the second guide groove 122 are in face-to-face contact, thus realizing mechanical connection. The power supply spring pieces 23 located on the first clamping piece 221 and/or the second clamping piece 222 elastically abut against the power supply conductive pieces 13 located in the first guide groove 121 and/or the second guide groove 122 to realize electrical connection, in this case, the relatively wide bottom wall 112 of the track 100 is accommodated in the relatively large first space 251, and the relatively narrow supporting part 16 is at least partially accommodated in the relatively small second space 252. With this arrangement, the track adapter 200 can be connected from outsides of the left sidewall 113 and the right sidewall 114 of the track 100, which is convenient for installation, and the track adapter 200 and the track 100 partially overlap in the height direction, thereby reducing a height of the electrical system 400 with the track adapter 200 and the track 100. Meanwhile, because the track adapter 200 is installed outside the track 100, the independent wireless control of the electrical system 400 can be realized, and the technical problem that a traditional track adapter 200 is installed inside a track 100 and the wireless communication signal is weak can be solved.

The connection body 21 includes a housing 211, the housing 211 includes an upper housing 2111 and a lower housing 2112. An installation space 2113 is formed between and surrounded by the upper housing 2111 and the lower housing 2112, and the first clamping piece 221 and the second clamping piece 222 and the pressing part 271 are at least partially accommodated in the installation space 2113. Optionally, a side of the lower housing 2112 close to the upper housing 2111 is provided with four combining parts 212, and the four combining parts 212 are located at four corners of the lower housing 2112. Each of the four combining parts 212 includes a first limiting baffle 2121 with an extension direction parallel to the first direction, a second limiting baffle 2122 with an extension direction parallel to the second direction, and a hollow fixing post 2123 located inside the first limiting baffle 2121 and the second limiting baffle 2122. The upper housing 2111 is provided with a through hole 2114, and fasteners such as bolts extend into the hollow fixing posts 2123 through the through holes 2114, so that the upper housing 2111 and the lower housing 2112 are fixedly connected through four combining parts 212. The first limiting baffle 2121 and the second limiting baffle 2122 are angularly arranged. Preferably, the first limiting baffle 2121 and the second limiting baffle 2122 are integrally formed. In the first direction, a distance between two adjacent first limit baffles 2121 is greater than a distance between two ends of the pressing part 271 exposed outside the installation space 2113, but less than a distance between two ends of the pressing part 271 accommodated inside the installation space 2113, thus a movable space is provided for the pressing part 271 to movably connect with the connection body 21 and meanwhile the pressing part 271 is prevented from falling off the connection body 21. In the second direction, a distance between two adjacent second limiting baffles 2122 is larger than a distance between two ends of the first clamping piece 221 or the second clamping piece 222 exposed outside the installation space 2113, but smaller than a distance between two ends of the first clamping piece 221 or the second clamping piece 222 accommodated inside the installation space 2113, thus a movable space is provided for the first clamping piece 221 and the second clamping piece 222 to movably connect with the connection body 21 and meanwhile the first clamping piece 221 and the second clamping piece 222 are prevented from falling off the connection body 21.

The first clamping piece 221 and the second clamping piece 222 are arranged in a U-shape, and both of the first clamping piece 221 and the second clamping piece 222 include a first part 223 located above the connection body 21 for clamping connection with the track 100, a second part 224 movably connected with the connection body 21, and a third part 225 connecting the first part 223 and the second part 224. There is a height difference between the first part 223 and the second part 224, which is not less than a thickness of the connection body 21, so that the connection body 21 can be at least partially accommodated in an U-shaped groove formed by the first part 223 and the second part 224, thereby facilitating the movable connection between the connection body 21 and the first clamping piece 221 and the second clamping piece 222.

The first part 223 is located above the connection body 21, and an orthographic projection of the first part 223 in a thickness direction of the track adapter 200 is located on the connection body 21. The first part 223 includes a first abutting surface 2231 close to the connection body 21 and a second abutting surface 2232 away from the connection body 21. The power supply spring piece 23 is located between the first abutting surface 2231 and the second abutting surface 2232, and at least partially exposed on the first abutting surface 2231 and/or the second abutting surface 2232 for electrically connecting with the power supply conductive piece 13 on the track 100.

The first part 223 may be integrally formed with the power supply spring piece 23, or may include an upper cover 2233 and a lower groove body 2234 assembled with the upper cover 2233 in the height direction, and the power supply spring piece 23 is sandwiched between the upper cover 2233 and the lower groove body 2234.

Optionally, the first part 223 includes the upper cover 2233 and the lower groove body 2234 assembled with the upper cover 2233 in the height direction. A peripheral wall of the upper cover 2233 is provided with a hook, and an inner peripheral wall of the lower groove body 2234 is correspondingly provided with a bayonet, and the hook extends into the bayonet, so that the upper cover 2233 and the lower groove body 2234 are snap-connected. The surface of the upper cover 2233 facing away from the lower groove body 2234 is the second abutting surface 2232, and the surface of the lower groove body 2234 facing away from the upper cover 2233 is the first abutting surface 2231. There is a gap between the first abutting surface 2231 and the second abutting surface 2232, and the power supply spring piece 23 is at least partially accommodated in this gap.

In this example, the power supply spring piece 23 includes a fixing part 231 and an abutting part 232 which are connected in sequence. The fixing part 231 is plate-shaped and accommodated in the gap, and the abutting part 232 protrudes in a direction close to the first abutting surface 2231 or the second abutting surface 2232 to form an inverted V-shaped structure. The first abutting surface 2231 and the second abutting surface 2232 are provided with connection openings 2235 at positions corresponding to the abutting part 232. The abutting parts 232 are exposed on the first abutting surface 2231 and/or the second abutting surface 2232 through the connection opening 2235, and are in contact with the power supply conductive pieces 13 of the track 100, thereby realizing the electrical connection between the track 100 and the track adapter 200.

The power supply spring piece 23 can have certain elasticity. In the case that the power supply spring piece 23 passes through the connection opening 2235 and is in contact with the power supply conductive piece 13, the power supply conductive piece 13 exerts a certain force on the power supply spring piece 23, and a restoring force of the power supply spring piece 23 enables the power supply spring piece 23 to better contact with the power supply conductive piece 13, thus realizing reliable electrical connection. The gap also provides a deformation space for the elastic deformation of the power supply spring piece 23. The inverted V-shaped abutting part 232 also facilitates the reliable deformation of the power supply spring piece 23 in the case that the power supply spring piece 23 is installed and stressed. In other examples, the power supply spring piece 23 may also have other structures, which is not limited by the present disclosure.

Optionally, the track adapter 200 further includes the signal spring pieces 24 arranged on the first clamping piece 221 and/or the second clamping piece 222. The signal spring pieces 24 pass through the connection openings 2235 in the first abutting surface 2231 and the second abutting surface 2232 and are in contact with the signal conductive pieces 14 on the track 100. In the case that the signal spring piece 24 is in contact with the signal conductive piece 14, the signal conductive piece 14 gives a certain force to the signal spring piece 24. A restoring force of the signal spring piece 24 enables the signal spring piece 24 to better contact with the signal conductive piece 14, thus realizing reliable signal connection to receive the control signal of the electrical system 400, thus realizing the intelligent control of the electrical system 400. The signal spring piece 24 is also arranged on the first part 223, and can be integrally formed with the first part 223 or sandwiched between the upper cover 2233 and the lower groove body 2234. In this example, the signal spring piece 24 and the power supply spring piece 23 have the same structure, so the details are not repeated here. In other examples, the structures of the signal spring piece 24 and the power supply spring piece 23 may be different, which is not limited by the present disclosure.

In an alternative example, the track adapter 200 includes two power supply spring pieces 23 and two signal spring pieces 24, and the arrangement of the two power supply spring pieces 23 and the two signal spring pieces 24 corresponds to the arrangement of the two power supply conductive pieces 13 and the two signal conductive pieces 14 of the track 100. For example, in the case that the two power supply conductive pieces 13 and the two signal conductive pieces 14 are staggered along the central axis of the main body 11 of the track 100, that is to say, in the case that the two power supply conductive pieces 13 are respectively arranged on the upper surface 125 of the first guide groove 121 and the lower surface 126 of the second guide groove 122, and two signal conductive pieces 14 are respectively arranged on the lower surface 126 of the first guide groove 121 and the upper surface 125 of the second guide groove 122, the two power supply spring pieces 23 and two signal elastic pieces 24 are also staggered along the central axis of the connection body 21 of the track adapter 200, that is to say, the two power supply spring pieces 23 are respectively exposed on the second abutting surface 2232 of the first clamping piece 221 and the first abutting surface 2231 of the second clamping piece 222, and the two signal spring pieces 24 are respectively exposed on the first abutting surface 2231 of the first clamping piece 221 and the second abutting surface 2232 of the second clamping piece 222, when the track adapter 200 is connected with the track 100, the electrical circuit and the control circuit are formed at the same time. As a variation, the power supply spring piece 23 and the signal spring piece 24 can also be staggered along the central axis of the connection body 21 in other ways, or the signal spring piece 24 and the power supply spring piece 23 are symmetrically arranged along the central axis of the connection body 21, or the signal spring piece 24 and the power supply spring piece 23 are symmetrically arranged along a direction perpendicular to the central axis. In other words, the power supply spring piece 23 and the signal spring piece 24 follow the installation positions of the power supply conductive piece 13 and the signal conductive member 14, and are interchanged left and right or up and down at the first abutting surfaces 2231 and the second abutment surfaces 2232 of the first clamping piece 221 and the second clamping piece 222, as long as the electrical circuit and the control circuit can be formed when the track 100 is connected with the track adapter 200.

In this example, the power supply spring piece 23 and the signal spring piece 24 are both elastic copper pieces. Under the action of the restoring force of the power supply spring piece 23, the power supply spring piece 23 is in contact with the power supply conductive piece 13 more closely, thus realizing reliable electrical connection. Under the action of the restoring force of the signal spring piece 24, the signal spring piece 24 is in contact with the signal conductive piece 14 more closely, thus realizing reliable signal connection. When the track adapter 200 slides on the track 100, the power supply spring piece 23 and the signal elastic piece 24 exposed outside of the first clamping piece 221 and the second clamping piece 222 on the track adapter 200 are always in contact with the power supply conductive piece 13 and the signal conductive piece 14 exposed in the first guide groove 121 and the second guide groove 122 on the track 100, which will not affect the power supply transmission and the signal transmission between the track adapter 200 and the track 100. In other examples, the power supply spring piece 23 and the signal spring piece 24 can also be made of other elastic metal materials, and the scope disclosed in the present disclosure is not limited in this aspect.

Further, in order to prevent the track adapter 200 from falling off the track 100 and improve the stability of the connection between the track adapter 200 and the track 100, the track adapter 200 further includes a locking assembly 26 and an unlocking assembly 27, the locking assembly 26 and the unlocking assembly 27 are at least partially accommodated in the installation space 2113 to improve the aesthetics of the track adapter 200. The locking assembly 26 is configured to lock and connect the first clamping piece 221 and the second clamping piece 222 with the connection body 21, thereby fixing the track 100 in the accommodating space 25, so that the track adapter 200 and the track 100 remain locked, that is to say, in a relatively static state. The unlocking assembly 27 is configured to unlock the locking connection between the first clamping piece 221 and the second clamping piece 222 and the connection body 21, so that the track adapter 200 and the track 100 are released, that is to say, they can slide relatively.

The locking assembly 26 includes locking parts 261 respectively located on the first clamping part 221 and the second clamping part 222, and an engagement part 2722 located on the unlocking assembly 27. The locking part 261 is matched and connected with the engagement part 2722 to lock the track adapter 200 on the track 100.

Optionally, the locking part 261 is disposed at a connection end 2241 of the second part 224 close to the connection body 21, and includes a first wall 2611 and a second wall 2612 which are arranged at a folded angle, the first wall 2611 is formed by extending horizontally from an end of the first part 223 to the connection body 21, and the second wall 2612 is formed at a folded angle of 90 degrees downward from an end of the first wall 2611. A locking groove for locking the engagement part 2722 is formed between the first wall 2611 and the second wall 2612. An inclined guide surface is provided at a side of the second wall 2612 close to the connection body 21 to guide the locking part 261 to connect and lock with the engagement part 2722. In other examples, the locking part 261 can also have other structures, which is not limited by the present disclosure.

The locking assembly 26 further includes two first elastic members 262, which are symmetrically arranged along the second direction, and elastic directions of the two first elastic members 262 are parallel to the first direction. An end of one of the two first elastic members 262 is elastically connected with the first clamping piece 221, and another end of the one is elastically connected with the connection body 21, an end of the other first elastic member 262 is elastically connected with the second clamping piece 222, and another end of the other first elastic member 262 is elastically connected with the connection body 21.

Optionally, ends of the first clamping piece 221 and second clamping piece 222 close to the first elastic member 262 are provided with protruding parts 2242, that is to say, the protruding part 2242 is arranged at the connection end 2241 of the second part 224, and a limiting groove 213 for limiting the first elastic member 262 is arranged in the connection body 21, an end of the first elastic member 262 is connected with the protruding part 2242, and another end abuts against the limiting groove 213.

The connection end 2241 is further provided with a first retaining wall 2243 extending in the second direction. The first retaining wall 2243 is accommodated in the installation space 2113 and is close to a center of the installation space 2113 relative to the second limiting baffle 2122, so as to prevent the first clamping piece 221 or the second clamping piece 222 from falling off the connection body 21.

The unlocking assembly 27 is arranged between the first clamping piece 221 and the second clamping piece 222, and is movably connected with the connection body 21, and includes the pressing part 271 and a movable plate 272 extending from a bottom of the pressing part 271 in a direction away from the pressing part 271. The pressing part 271 and the movable plate 272 can be integrally arranged or separately arranged and connected by assembly, which is not limited in the present disclosure.

The pressing part 271 is at least partially accommodated in the installation space 2113, and a second retaining wall 2711 extending in the first direction is provided at an end of the pressing part 271 close to the installation space 2113. The second retaining wall 2711 is accommodated in the installation space 2113 and is close to the center of the installation space 2113 relative to the first limiting baffle 2121 to prevent the pressing part 271 from falling off the connection body 21.

The movable plate 272 is accommodated in the installation space 2113 and can slide in the second direction relative to the lower housing 2112. In the connection body 21, guide parts 214 are provided at positions corresponding to two ends of the movable plate 272, the guide parts 214 extend from the lower housing 2112 to a direction close to the upper housing 2111 and are configured to guide a moving direction of the movable plate 272 in the connection body 21. That is to say, because of the existence of the guide part 214, the movable plate 272 can only slide relative to the lower housing 2112 in the second direction. The two guide parts 214 and a baffle 215 located between the guide parts 214 form an accommodating groove 216 for accommodating and limiting the movable plate 272. The movable plate 272 includes a yielding part 2721 and the engagement part 2722 which are arranged in sequence from a position close to the pressing part 271 to a position away from the pressing part 271. The engagement part 2722 is formed by the movable plate 272 extending in a direction away from the lower housing 2112, and is used for engaging with the locking part 261 to realize the locking connection between the first clamping piece 221 and the second clamping piece 222 and the connection body 21. When the two movable plates 272 move towards each other, the two engagement parts 2722 move towards each other, thus sliding out of the locking groove. At this time, because of the existence of the yielding part 2721, the locking part 261 and the engagement part 2722 are released from the locking connection, thereby releasing the locking connection between the first clamping part 221 and the second clamping part 222 and the connection body 21.

The unlocking assembly 27 further includes second elastic members 273, two second elastic members 273 are provided, the two second elastic members 273 are symmetrically arranged along the first direction, and elastic directions of the two second elastic members 273 are parallel to the second direction. An end of each of the two second elastic members 273 is elastically connected with the movable plate 272, and another end of each of the two second elastic members 273 is elastically connected with the connection body 21. The movable plate 272 is further provided with a reinforcing plate 2723 extending in parallel with the engagement part 2722, and an end of the reinforcing plate 2723 close to the second elastic member 2733 is provided with a first sleeve joint part 2724. The connection body 21 is provided with the baffle 215, and a side of the baffle 215 close to the second elastic member 273 is provided with a second sleeve joint part 2151. An end of the second elastic member 273 is sleeved on the first sleeve joint part 2724, and another end is sleeved on the second sleeve joint part 2151.

Further, in the moving direction of the movable plate 272, that is to say, in the second direction, a distance between the first sleeve joint part 2724 and the second sleeve joint part 2151 is greater than a length of the engagement part 2722. In this way, the engagement part 2722 has enough moving space, so as to release the locking connection between the first clamping part 221 and the second clamping part 222 and the connection body 21.

Please refer to FIGS. 20-26, which show an electrical system 400 according to an example of the present disclosure. The electrical system 400 includes a track 100, a track adapter 200 and an electrical device 300, and the electrical device 300 is coupled to the track 100 through the track adapter 200. In this example, the electrical device 300 is a lighting fixture, which is used for accent lighting of a local region. At the same time, the lighting assembly 17 is further arranged in the track 100, so that the electrical system 400 can provide supplementary lighting at a part of the track 100 where no lighting fixture is installed without affecting the use of the track 100, thus improving the lighting environment and lighting effect, effectively utilizing the space of the track 100 and meeting the lighting requirements of the districts. That is to say, the electrical system 400 of the present disclosure has the functions of both main lighting and auxiliary lighting, and the auxiliary lighting makes the whole light transparent, bright and textured. Alternatively, the lighting assembly 17 can use RGB color light sources to set off the atmosphere. In other examples, the lighting fixture and the lighting assembly 17 are controlled separately, for example, the lighting fixture is not installed in the lighting environment without special requirements, so as to meet the different use requirements of users and improve the user's experience.

In this example, the electrical system 400 further includes a driving power supply, which can be arranged in the installation foundation to provide appropriate power supply for the track 100 and the electrical system 400 with the track 100 without affecting the aesthetics of the electrical system 400. In other examples, the driving power supply can also be assembled on the track or placed outside the track, which is not limited by the present disclosure.

In this example, the electrical device 300 is only used for illustrative purposes and is not intended to limit the scope of the present disclosure. It is understood by those skilled in the art that the electrical device 300 can be of various types suitable for the installation on the track 100. For example, the electrical device 300 can be a power consumption device such as a lighting fixture, a monitoring device, an intelligent control device or a sensor module, and can also be a power supply device such as a driving power supply. The present disclosure is not limited thereto.

In an alternative example, the electrical device 300 is a driving power supply, and the driving power supply can also be directly coupled to the track 100, and other electrical device 300, such as the lighting fixture, the monitoring device, the intelligent control device or the sensor module, can be coupled to the driving power supply. In this case, the driving power supply is integrated with the track adapter 200, that is to say, the driving power supply is arranged in the track adapter 200 to receive the power of the commercial power and convert it into the power required by the other electrical device 300. Or the other electrical device 300, such as lighting fixture, the monitoring device, the intelligent control device or the sensor module, can also be provided with its own driving device to realize power conversion, which is not limited by the present disclosure.

Please continue to refer to FIGS. 20-26, and as illustrated by FIGS. 14 and 18, the lower housing 2112 of the track adapter 200 can further be provided with a connection hole 2115. Correspondingly, the track adapter 200 further includes a hollow connection rod 28 passing through the connection hole 2115. The hollow connection rod 28 is suitable for coupling the electrical device 300. For example, wires can be arranged in the hollow connection rod 28 for electrically connecting the track adapter 200 and the electrical device 300. With this arrangement, the electrical device 300 can be easily coupled to the track adapter 200, and the mechanical and electrical connection between the electrical device 300 and the track adapter 200 can be realized. In other examples, the electrical device 300 may be directly connected to the track adapter 200 without additional components interposed between the electrical device 300 and the track adapter 200. Alternatively, the electrical system 400 may further include more connection pieces interposed between the electrical device 300 and the track adapter 200, and the scope of the present disclosure is not limited in this aspect.

Referring to FIGS. 20-26, when it is needed to connect the track adapter 200 coupled with the electrical device 300 with the track 100, the first clamping piece 221 and the second clamping piece 222 of the track adapter 200 extend into the first guide groove 121 and the second guide groove 122 of the track 100 to realize the mechanical connection between the track adapter 200 and the track 100, at the same time, the power supply spring piece 23 and the signal elastic piece 24 located on the first clamping piece 221 and the second clamping piece 222 are elastically abutted with the power supply conductive piece 13 and the signal conductive piece 14 located in the first guide groove 121 and the second guide groove 122, respectively, so as to realize the electrical connection between the track adapter 200 and the track 100. The electrical system 400 is convenient and quick to install, and the track adapter 200 and the track 100 partially overlap in the thickness direction (i.e., the height direction) of the track 100 when the track adapter 200 and the track 100 are connected, so that a thickness of the electrical system 400 can be effectively reduced and the occupied space of the electrical system 400 can be reduced.

When the track adapter 200 slides to a position where lighting is needed, external forces are applied to the first clamping piece 221 and the second clamping piece 222 of the track adapter 200, so that the first clamping piece 221 and the second clamping piece 222 move towards each other, and the locking parts 261 on the first clamping piece 221 and the second clamping piece 222 are locked with the engagement parts 2722 on the movable plate 272 to fix the engagement parts 2722 in the locking grooves, and the locking connection between the first clamping piece 221 and the second clamping piece 222 and the connection body 21 is realized, so that the track 100 is fixed in the accommodating space 25 of the track adapter 200, and the locking connection between the track 100 and the track adapter 200 is realized, thereby preventing potential safety hazards caused by the track adapter 200 falling off the track 100 when the electrical device 300 rotates, and improving the safety of the electrical system 400. When the lighting position needs to be changed or the connection between the track adapter 200 and the track 100 needs to be released, external forces are applied to the pressing parts 271 of the unlocking assembly 27, so that the two pressing parts 271 move towards each other, and the engagement part 2722 slides out of the locking groove, because of the existence of the yielding part 2721, the locking part 261 and the engagement part 2722 are released from the locking connection, and the first clamping part 221 and the second clamping part 222 slide away from each other under the elastic force of the first elastic member 262, returning to an initial state. At this time, cancelling the external force, the pressing part 271 returns to an initial state under the elastic force of the second elastic member 2733. In this way, the locking connection between the first clamping piece 221 and the second clamping piece 222 and the connection body 21 can be released, so that the track 100 can move in the accommodating space 25 of the track adapter 200, that is to say, the locking connection between the track 100 and the track adapter 200 can be released, and the track adapter 200 can slide relative to the track 100.

Please refer to FIG. 27, which shows an electrical system 400 according to another example of the present disclosure. In this example, a lighting module is integrated in the track adapter 200, thus avoiding coupling the electrical device 300 to the track adapter 200 and reducing the occupied space of the electrical system 400. The lighting module can be a grid light or a linear light, etc., which is not limited by the present disclosure.

In summary, in the track adapter 200, the track 100 and the electrical system 400 of the present disclosure, the track adapter 200 has a simple structure, by the first clamping piece 221 and the second clamping piece 222 being disposed to face each other, can be mechanically connected and electrically connected with the track 100 from the outer side of the track 100, which is easy and convenient to install, and the stability of the connection between the track adapter 200 and the track 100 is improved, meanwhile, the accommodating space 25 for partially housing the track 100 is formed on the track adapter 200, so that the track 100 and the track adapter 200 can be partially overlapped in the height direction, thus, the height of the track 100 and the track adapter 200 are effectively reduced, and the occupied space thereof is reduced.

The purpose of the present disclosure is to provide a track adapter with simple and convenient installation and high connection stability.

In order to achieve the above purpose, the present disclosure provides a track adapter, configured for coupling an electrical device to a track, and including: a connection body, a first clamping piece and a second clamping piece respectively movably connected to the connection body, and a power supply spring piece provided on the first clamping piece and/or the second clamping piece for electrical connection, wherein the first clamping piece and the second clamping piece are disposed facing each other from opposite sides of the connection body, and the first clamping piece, the second clamping piece and the connection body enclose to form an accommodating space at least partially housing the track.

As a further improvement of the present disclosure, the first clamping piece and the second clamping piece each include a first abutting surface disposed close to the connection body and a second abutting surface disposed away from the connection body, the power supply spring piece is located between the first abutting surface and the second abutting surface and is at least partially exposed to the first abutting surface and/or the second abutting surface.

As a further improvement of the present disclosure, a gap is provided between the first abutting surface and the second abutting surface, and the power supply spring piece is at least partially housed within the gap.

As a further improvement of the present disclosure, the track adapter further includes a signal spring piece provided on the first clamping piece and/or the second clamping piece; the signal spring piece and the power supply spring piece are symmetrically arranged along a central axis of the connection body; or the signal spring piece and the power supply spring piece are staggered along the center axis; or the signal spring piece and the power supply spring piece are symmetrically arranged along a direction perpendicular to the center axis.

As a further improvement of the present disclosure, the track adapter further includes a locking assembly and an unlocking assembly, the locking assembly is configured to lock and connect the first clamping piece and the second clamping piece with the connection body, and the unlocking assembly is configured to unlock locking connection of the first clamping piece and the second clamping piece with the connection body.

As a further improvement of the present disclosure, the locking assembly includes locking parts respectively located on the first clamping piece and the second clamping piece, and engagement parts located on the unlocking assembly, wherein the locking parts are matched and connected with the engagement parts to lock the track adapter.

As a further improvement of the present disclosure, the locking assembly further includes a first elastic member, an end of the first elastic member is elastically connected to the first clamping piece/the second clamping piece, and another end of the first elastic member is elastically connected to the connection body; the first clamping piece/the second clamping piece is provided with a protruding part at an end thereof close to the first elastic member, the connection body is provided with a limiting groove for limiting the first elastic member, an end of the first elastic member is connected with the protruding part, and another end of the first elastic member abuts the limiting groove.

As a further improvement of the present disclosure, the unlocking assembly is provided between the first clamping piece and the second clamping piece, and is movably connected with the connection body, and the unlocking assembly includes a pressing part and a movable plate extending from a bottom of the pressing part toward a direction away from the pressing part, the movable plate includes a yielding part and an engagement part disposed sequentially from a position close to the pressing part towards a position away from the pressing part.

As a further improvement of the present disclosure, the unlocking assembly further includes a second elastic member, an end of the second elastic member is elastically connected with the movable plate, and another end of the second elastic member is elastically connected with the connection body; the movable plate is provided with a first sleeve joint part at an end thereof close to the second elastic member, the connection body is provided with a baffle, the baffle is provided with a second sleeve joint part at a side thereof close to the second elastic member, an end of the second elastic member is sleeved on the first sleeve joint part, and another end of the second elastic member is sleeved on the second sleeve joint part.

As a further improvement of the present disclosure, a distance between the first sleeve joint part and the second sleeve joint part is greater than a length of the engagement part in a moving direction of the movable plate.

As a further improvement of the present disclosure, a guide part is provided in the connection body at a position corresponding to the movable plate, and the guide part is configured to guide a moving direction of the movable plate in the connection body.

As a further improvement of the present disclosure, the connection body includes a housing and an installation space enclosed by the housing, the locking assembly and the unlocking assembly are at least partially housed within the installation space.

As a further improvement of the present disclosure, a connection hole is provided at a bottom of the housing, the track adapter further includes a hollow connection rod passing through the connection hole, the hollow connection rod is configured to couple to the electrical device.

The second purpose of the present disclosure is to provide a track matched and connected with the abovementioned track adapter.

In order to achieve the above purpose, the present disclosure provides a track, and the track is configured to be mechanically connected and electrically connected with the abovementioned track adapter.

The third purpose of the present disclosure is to provide an electrical system including the abovementioned track adapter.

In order to achieve the above purpose, the present disclosure provides an electrical system, including the abovementioned track adapter; the electrical system further includes a track and an electrical device, wherein the electrical device is coupled to the track through the track adapter.

The present disclosure has the following beneficial effect: compared with the existing art, the track adapter of present disclosure can be mechanically connected and electrically connected with the track from the outer side of the track through the first clamping piece and the second clamping piece that are disposed to face each other, the installation is easy and convenient, the stability of the connection between the track adapter and the track is improved, meanwhile, the accommodating space for partially housing the track is formed on the track adapter, so that the track and the track adapter can be partially overlapped in the height direction, thereby effectively reducing the height of the track and the track adapter, and reducing the occupied space thereof.

The present disclosure may include dedicated hardware implementations such as disclosure specific integrated circuits, programmable logic arrays and other hardware devices. The hardware implementations can be constructed to implement one or more of the methods described herein. Examples that may include the apparatus and systems of various implementations can broadly include a variety of electronic and computing systems. One or more examples described herein may implement functions using two or more specific interconnected hardware modules or devices with related control and data signals that can be communicated between and through the modules, or as portions of an disclosure-specific integrated circuit. Accordingly, the system disclosed may encompass software, firmware, and hardware implementations. The terms “module,” “sub-module,” “circuit,” “sub-circuit,” “circuitry,” “sub-circuitry,” “unit,” or “sub-unit” may include memory (shared, dedicated, or group) that stores code or instructions that can be executed by one or more processors. The module refers herein may include one or more circuit with or without stored code or instructions. The module or circuit may include one or more components that are connected.

The above examples are only used to illustrate the technical scheme of the disclosure, but not to limit it. Although the disclosure has been described in detail with reference to the examples, it should be understood by those skilled in the art that the technical scheme of the disclosure can be modified or replaced by equivalents without departing from the spirit and scope of the technical scheme of the disclosure.

1. A track adapter, configured for coupling an electrical device to a track, and comprising:
a connection body, a first clamping piece and a second clamping piece movably connected to the connection body, and a power supply spring piece provided on the first clamping piece and/or the second clamping piece for electrical connection, and wherein:
the first clamping piece and the second clamping piece are disposed facing each other from opposite sides of the connection body, and the first clamping piece, the second clamping piece and the connection body enclose to form an accommodating space at least partially housing the track.

2. The track adapter according to claim 1, wherein the first clamping piece and the second clamping piece each comprise a first abutting surface disposed close to the connection body and a second abutting surface disposed away from the connection body, the power supply spring piece is located between the first abutting surface and the second abutting surface and is at least partially exposed to the first abutting surface and/or the second abutting surface.

3. The track adapter according to claim 2, wherein a gap is provided between the first abutting surface and the second abutting surface, and the power supply spring piece is at least partially housed within the gap.

4. The track adapter according to claim 1, wherein the track adapter further comprises a signal spring piece provided on the first clamping piece and/or the second clamping piece;
the signal spring piece and the power supply spring piece are symmetrically arranged along a central axis of the connection body; or
the signal spring piece and the power supply spring piece are staggered along the center axis; or
the signal spring piece and the power supply spring piece are symmetrically arranged along a direction perpendicular to the center axis.

5. The track adapter according to claim 1, wherein the track adapter further comprises a locking assembly and an unlocking assembly, the locking assembly is configured to lock and connect the first clamping piece and the second clamping piece with the connection body, and the unlocking assembly is configured to unlock locking connection of the first clamping piece and the second clamping piece with the connection body.

6. The track adapter according to claim 5, wherein the locking assembly comprises locking parts located on the first clamping piece and the second clamping piece, and engagement parts located on the unlocking assembly, and wherein the locking parts are matched and connected with the engagement parts to lock the track adapter.

7. The track adapter according to claim 6, wherein:
the locking assembly further comprises a first elastic member, an end of the first elastic member is elastically connected to the first clamping piece/the second clamping piece, and another end of the first elastic member is elastically connected to the connection body; and
the first clamping piece/the second clamping piece is provided with a protruding part at an end thereof close to the first elastic member, the connection body is provided with a limiting groove for limiting the first elastic member, an end of the first elastic member is connected with the protruding part, and another end of the first elastic member abuts the limiting groove.

8. The track adapter according to claim 5, wherein the unlocking assembly is provided between the first clamping piece and the second clamping piece, and is movably connected with the connection body, and the unlocking assembly comprises a pressing part and a movable plate extending from a bottom of the pressing part toward a direction away from the pressing part, the movable plate comprises a yielding part and an engagement part disposed sequentially from a position close to the pressing part towards a position away from the pressing part.

9. The track adapter according to claim 8, wherein:
the unlocking assembly further comprises a second elastic member, an end of the second elastic member is elastically connected with the movable plate, and another end of the second elastic member is elastically connected with the connection body; and
the movable plate is provided with a first sleeve joint part at an end thereof close to the second elastic member, the connection body is provided with a baffle, the baffle is provided with a second sleeve joint part at a side thereof close to the second elastic member, an end of the second elastic member is sleeved on the first sleeve joint part, and another end of the second elastic member is sleeved on the second sleeve joint part.

10. The track adapter according to claim 9, wherein a distance between the first sleeve joint part and the second sleeve joint part is greater than a length of the engagement part in a moving direction of the movable plate.

11. The track adapter according to claim 8, wherein a guide part is provided in the connection body at a position corresponding to the movable plate, and the guide part is configured to guide a moving direction of the movable plate in the connection body.

12. The track adapter according to claim 5, wherein the connection body comprises a housing and an installation space enclosed by the housing, the locking assembly and the unlocking assembly are at least partially housed within the installation space.

13. The track adapter according to claim 12, wherein a connection hole is provided at a bottom of the housing, the track adapter further comprises a hollow connection rod passing through the connection hole, the hollow connection rod is configured to couple to the electrical device.

14. A track, configured to be mechanically connected and electrically connected with a track adapter, wherein the track adapter is configured for coupling an electrical device to the track, and the track adapter comprise:
a connection body, a first clamping piece and a second clamping piece movably connected to the connection body, and a power supply spring piece provided on the first clamping piece and/or the second clamping piece for electrical connection, and wherein:
the first clamping piece and the second clamping piece are disposed facing each other from opposite sides of the connection body, and the first clamping piece, the second clamping piece and the connection body enclose to form an accommodating space at least partially housing the track.

15. An electrical system, comprising a track adapter a track and an electrical device, wherein the electrical device is coupled to the track through the track adapter, and the track adapter is configured for coupling an electrical device to the track, and the track adapter comprise:
a connection body, a first clamping piece and a second clamping piece movably connected to the connection body, and a power supply spring piece provided on the first clamping piece and/or the second clamping piece for electrical connection, and wherein:
the first clamping piece and the second clamping piece are disposed facing each other from opposite sides of the connection body, and the first clamping piece, the second clamping piece and the connection body enclose to form an accommodating space at least partially housing the track.
